(19) United States
(12) Patent Application Publication
(10) Pub. No.: US 2024/0124335 A1
(43) Pub. Date: Apr. 18, 2024

(54) DESALINATION DEVICE AND PROCESS FOR RECOVERY AND VALORISATION OF CHLORIDES IN DILUTE SOLUTIONS

(71) Applicant: GENIO SRL, Milano (IT)

(72) Inventors: Stefano CAVALLI, Peschiera del Garda (VR) (IT); Marco TREVISAN, Peschiera del Garda (VR) (IT)

(21) Appl. No.: 18/264,896

(22) PCT Filed: Feb. 9, 2022
(86) PCT No.: PCT/IB2022/051149

§ 371 Date: Aug. 9, 2023

(30) Foreign Application Priority Data
Feb. 10, 2021 (IT) 102021000002963

(51) Int. Cl. C02F 1/461; C25B 1/04; C25B 9/21; C25B 11/03; C25B 11/043; C25B 11/046; C25B 15/08

(52) U.S. Cl. CPC C02F 1/4618; C02F 1/46109; C25B 1/04; C25B 9/21; C25B 11/03; C25B 11/043; C25B 11/046; C25B 15/087; C02F 2103/08; C02F 2201/46115

(57) ABSTRACT

The invention relates to a device and a process for the desalination of NaCl solutions employing a three-chamber electrochemical cell separated by relative ion exchange membranes, namely a succession of a cathode chamber, a cation exchange membrane, a central chamber for the saline solution, an anion exchange membrane and an anode chamber. The oxidation of OH⁻ and the reduction of H₃O⁺ under the formation of OH⁻ and H₂ causes the passage of Na and Cl⁻ ions from the central chamber to the other chambers, thereby reducing the salt concentration. The feeding of the cathode chamber can be managed in a circuit with the insertion of a carbonation reactor to reduce the concentration of NaOH and eliminate CO₂ from the air. Under certain conditions, the chlorides entering the anode chamber undergo oxidation and the chlorine formed therein reacts with water to produce HCl and HClO.

### TECHNICAL FIELD

The present invention relates to a desalination device and process for the recovery and valorisation treatment of chlorine-containing solutions from industrial, mining or water treatment wastes, including marine brines, by way of non-limiting example, for the production of disinfectants and the sequestration of atmospheric CO₂, for example.

### PRIOR ART

The reduction of chloride levels below the levels permitted for spillage into surface water (generally in the order of 1,000 ppm) is one of the main issues in the field of water treatment, since chlorides, unlike other elements or compounds such as calcium, magnesium, sulphates, and so forth, cannot be treated in physical-chemical plants by exploiting poorly soluble salts, oxides, hydroxides or flocculating agents.

However, chlorine salts, i.e. chlorides, are one of the most common pollutants of waste water from industrial processes (the food, textile, metal treatment and galvanic industries, etc.), mining, oil extraction (fracking) and, last but not least, form activities related to the desalination of marine water for the production of potable water for human consumption.

To date, the most commonly used methods for chloride abatement below the permitted limits for spillage into surface water depend strongly on their level of chloride concentration. In the case of levels close to the threshold (<5,000 ppm), generally the wastewater is mixed with other wastewater with a low chloride content and then undergoes chemical and physical treatment of the resulting mixture. For concentrations above 70,000 ppm, the only applicable technologies involve evaporation methods that make it possible to recover a volume of water by concentrating it until it (possibly) reaches saturation, with a subsequent solid recovery of chlorine salts. In the case of intermediate concentrations between 5,000 and 70,000 ppm, the method normally consists in applying, in series, a purification by means of osmotic membrane and consequently an evaporative recovery of the concentrated osmotic rejection.

Needless to say, given the high plant and energy costs related to reverse osmosis and evaporation treatments, it is not uncommon to see fraudulent phenomena of environmental spillage or relocation, where possible, to countries with inadequate environmental regulations that permit spillage into surface water.

A further method developed in the early 2000s and marketed by the Applicant under the name SMIT is the subject matter of the European patent EP 3 250 516, and provides for the use of an electrochemical apparatus to extract the chlorine salts dissolved in an aqueous solution while simultaneously producing an aqueous solution depleted of chlorine salts and two chemical compounds, one of which is hydrochloric acid HCl and the other a base, by an inverse acid-base neutralisation process. The process disclosed in the aforementioned patent provides for the use of two electrodes enriched with a catalyst that, by supplying the cell with atmospheric oxygen and hydrogen, makes it possible to obtain two chemical reactions on the surfaces of the electrodes that result in the production on one side of H⁺ ions and on the other of OH⁻ ions. Due to the principle of electro-neutrality of the aqueous solutions, the increase in the concentration of these ionic species in the chamber containing the two electrodes involves the displacement of the charged ionic species contained in the treated brine through dedicated anion and cation membranes with consequent sequestration thereof.

Despite the great advantage introduced by this technology given by the fact that it is possible to obtain a chemical valorisation of treated brines and a consequent production of electric energy from the electrochemical process involved, this technology has several problems, summarised here below:

The high cost of the catalysts used for the production of the electrodes (such as platinum oxides) implies a high initial outlay for the construction of a plant that makes its application possible only in the event that the treated wastewater entails very high disposal costs. The solutions produced, both acidic and basic, cannot be produced at a desired concentration since the pH of the two solutions must be kept above 1 in the case of the acidic solution and below 13 in the case of the basic solution.

The use of a spontaneous reaction does not make it possible to control the production rate of H⁺ and OH ions, ⁻ since this process is directly proportional to the electrical conductivity of the treated brine. This phenomenon involves a decrease in the production rate of ions as the salinity of the treated brine decreases, thus making this type of technology economically uncompetitive in the case of brines containing less than 35,000 ppm of chlorides.

Finally, the need to supply the cell with hydrogen gas requires that a SMIT type plant be flanked by a plant for the in situ production of hydrogen. These plants can be built using water electrolysis technology or reforming of fossil and non-fossil hydrocarbons. This does not determine a limit in the case of applications in zones close to urbanised areas; however, it does represent a technical limit in the case in which the area involved for the realisation of the plants is not equipped for the management of constant supplies of hydrocarbons.

The desalination system described in WO 2016/120717 A1 works with diffusion electrodes and oxidises at H₂ the anode to form H⁺ and reduces O₂ at the cathode to form OH⁻ to turn brackish water into drinking water.

### SUMMARY OF THE INVENTION

The object of the invention is to overcome the aforementioned drawbacks and to propose a device and a process for the recovery and valorisation of chlorides in dilute solutions, in particular brines with chloride concentrations that can be lower than 35,000 ppm and higher than 5,000 ppm.

The invention also has the object of proposing a device and a process for the recovery treatment of solutions containing chlorides with low management and investment costs and which can valorise the treated compounds chemically.

Further purposes or advantages of the invention will be apparent from the following description.

In a first aspect of the invention, the object is achieved by means of a desalination device comprising at least one electrochemical cell comprising:
(a) an anode suitable for permitting the electrochemical reaction of oxidation of the OH⁻ ion and consequent production of gaseous oxygen and release of H+ protons in a solution wherein said anode is contained in an anode chamber adapted to contain or else containing an acid solution as an anolyte;
(b) a cathode connected through an electrical connection to said anode and adapted to make possible the electrochemical reaction of reduction of the proton H+ and consequent production of hydrogen gas and release in solution of OH− ions wherein said cathode is contained in a cathode chamber adapted to contain or else containing a basic solution as a catholyte, in particular an aqueous solution of NaOH;
(c) a system for feeding said anode chamber with the anolyte;
(d) a system for feeding said cathode chamber with catholyte;
(e) an OH⁻ ion impermeable and cation permeable cation exchange membrane, in particular permeable for Nat;
(f) an H⁺ ion impermeable and anion permeable anion exchange membrane, in particular permeable for Cl⁻;
wherein said anode chamber and said cathode chamber are separated by said cation exchange membrane and by said anion exchange membrane which, in turn, are separated by a third chamber adapted to contain or else containing an aqueous solution of chloride salts, particularly NaCl,
where
(α) said cation exchange membrane is simultaneously a wall, or part thereof, of said cathode chamber and of said third chamber, so that a salt cation passage, in particular for Na⁺ is possible from the third chamber to the cathode chamber;
(β) said anion exchange membrane is simultaneously a wall or a part thereof of said anode chamber and of said third chamber, such that from the third chamber to the anode chamber a passage of salt anions, in particular Cl−, is possible.

In preferred variants, said electrodes are made of stainless steel or graphite. Advantageously, said membranes are made of reinforced polymeric material, in particular polyketones (PK). Materials for electrodes and membranes can be different; they must simply be suitable for the reactions and permeabilities specified above. The person skilled in the art can easily identify suitable electrodes and membranes.

In a preferred embodiment of the invention, the desalination device (i.e. the relative control unit adapted to manage its various components included in the device) is configured to perform the following algorithm:
(i) feeding the anode chamber (14; 114) via the system for feeding said anode chamber with anolyte, preferably water;
(ii) feeding the cathode chamber (16; 116) via the system for feeding said cathode chamber with the catholyte, preferably water, or the base produced therein at reduced concentration;
(iii) feeding the third chamber (12; 112) with a concentrated chloride salt solution;
(iv) oxidation of OH⁻ on the anode (18) with the formation of oxygen O² and H⁺ protons;
(v) reduction of H⁺ on the cathode (20) with the formation of H₂ hydrogen and OH⁻ hydroxide ions.

The anion membrane retains within the anode acidification chamber the protons H⁺, making possible, however, the transit of negative ions such as the chloride ion Cl⁻ from the central chamber. The central chamber is preferably made in such a way as to allow the transit of the treated saline solution and to maximise the residence time of the same within the chamber while minimising the active surface area used. The active surface is intended as the two walls of the chamber delimited respectively by the anion membrane and the cation membrane.

Conversely, the cation membrane retains the OH⁻ ions within the basic production cathode chamber, while nevertheless allowing the transit of positive ions such as the sodium ion Na⁺ from the central chamber.

In order to ensure continuity of electrochemical reactions and migration of salt ions from the solution to be treated in the anode chamber and in the cathode chamber, in said desalination device according to the invention each of said chambers is preferably provided with an inlet and an outlet, specifically:
(a) the anode chamber is provided with an inlet for the fresh anolyte and an outlet for the more acidic anolyte enriched with saline anions, in particular Cl⁻ or derivatives thereof, and oxygen;
(b) the cathode chamber is provided with an inlet for the fresh catholyte and an outlet for the more basic catholyte enriched with salt cations, in particular Na⁺ and hydrogen; and
(c) the third chamber is provided with an inlet for the initial salt solution and an outlet for the reduced concentration salt solution.

In a particularly advantageous embodiment of the invention, the desalination device further comprises:
(g) a gas-liquid separation device, in particular a gas-liquid scrubber, adapted to recover the hydrogen produced which is connected to the outlet of the cathode chamber and which is preferably connected to a fuel cell.

A gas-liquid separation device makes it possible to recover the share of hydrogen produced from the base production chamber, thus in the cathode chamber, in order to reuse it in situ, for example, for the production of electricity by means of a fuel cell. The electric energy produced can be used immediately to power the electrochemical cell of the desalination device, resulting in a reduction of the power necessary to feed it by up to 15% from a direct source. Other gas-liquid separation systems are also known in the state of the art.

A particularly preferred embodiment of the invention provides that the desalination device further comprises:
(h) a carbonation reactor with the cathode chamber comprising an inlet and an outlet which are connected to a circuit into which said carbonation reactor is inserted.

The carbonation reactor advantageously diffuses a gas containing carbon dioxide within the basic solution produced and circulates in a circuit between the cathode chamber and the carbonation reactor. This procedure allows the pH of the basic solution to remain buffered, advantageously between 8.5 and 9.5, ensuring optimal operation and durability of the membranes. By maintaining the buffered pH it is also possible to increase the concentration of reagent taken from the treatment solution, until a solution of saturated carbonates is obtained which can then be taken continuously from the solution by way of precipitation. When fed with atmospheric air, the reactor helps to reduce its CO₂ charge. The carbonation reactor therefore has the dual purpose of maintaining the pH of the basic solution in the cathode chamber buffered and of allowing the sequestration of atmospheric carbon dioxide through the production of solid carbonates and bicarbonates that can be extracted from the solution by crystallisation through supersaturation.

Advantageously, the fresh anolyte is simply water or a solution with a pH close to 7, while the fresh catholyte advantageously is a diluted basic solution, preferably coming from the NaOH recirculation produced in the cathode chamber and buffered during passage through a decarbonation reactor. The fresh salt solution is advantageously a concentrated NaCl solution. These fresh solutions then undergo chemical reactions, as in the anode chamber:

2OH⁻ [symbol] O₂(g)+2H⁺+4e⁻

and in the cathode chamber:

2H₃O⁺+4e⁻ [symbol] 2OH⁻+2H₂(g).

An acid is then formed in the anode chamber and a base in the cathode chamber.

Another aspect of the invention relates to an electrochemical cell suitable for use in the desalination device according to the invention. It preferably comprises:
(i) a first plate supporting in a first window applied to said first plate said anode chamber of meandering path having a thickness with respect to the plane of the meandering path extension preferably not exceeding 6 mm and having an inlet and an outlet for the anolyte at its ends;
(ii) a second plate supporting in a second window applied in said second plate said central chamber of meandering path with a thickness with respect to the plane of the extension of the meandering path which preferably does not exceed 6 mm and with an inlet and an outlet for the saline solution at its ends; and
(iii) a third plate supporting in a third window applied to said third plate said cathode chamber of meandering path with a thickness with respect to the plane of the extension of the meandering path that preferably does not exceed 6 mm and with an inlet and an outlet for the catholyte at its ends,
(iv) said anion exchange membrane interposed between said first and said second plates;
(v) said cation exchange membrane interposed between said second and said third plate;
(vi) a plate anode disposed next to said first plate on the side opposite the position of the anion exchange membrane; and
(vii) a plate cathode disposed next to said third plate on the side opposite the position of the anion exchange membrane;
wherein plates, membranes and electrodes are superimposed in the following order: anode, anode chamber, anion exchange membrane, central chamber, cation exchange membrane, cathode,
wherein each plate is optionally provided with a plurality of first holes arranged such that with the overlapping of the plates they are aligned so that they can be connected with relevant fixing means;
wherein each plate is provided with a plurality of second holes divided into three pairs of holes for conveying the flows of anolyte, catholyte and saline solution into separate channels, one hole of each pair provided for the entry of the respective flow into the system and the other hole for the exit from the system where the corresponding holes are arranged in such a way that with the overlapping of the plates they are aligned so that they can be connected to form separate channels for the relative flows,
wherein each plate is preferably provided with a plurality of third holes for the collection of gases formed respectively in the anode and cathode chamber and arranged such that with the overlapping of the plates they are aligned so that they can be connected to form separate channels for the relative gas flows of the respective chambers,
wherein each flow passes through the entire system along the channel formed by the relative overlapping holes, but a communication with the inlet of the chamber is realised only in the plate which carries the chamber to which the relative channel flow is dedicated, in such a way as to allow the flow to pass through the chamber and enter through the outlet of the chamber into the corresponding outlet channel formed by the respective series of holes.

The realisation of the electrochemical cells in the form of three plates with meandering or serpentine chambers makes it possible to have a maximum surface, hence a maximum contact surface between each chamber and the relative ion exchange membrane, with a minimum of thickness or volume of the chambers themselves, a practically laminar extension of the chambers obtaining a uniform and homogeneous distribution of the corresponding solutions contained therein and guaranteeing regular degassing. The meandering shape makes it possible to create a long path of solutions inside each chamber in a very small space.

In combination with an optimized contact surface, this space saving makes possible the reduction of the area of the membranes needed to separate the individual cells, a highly significant fact in view of the high costs for membranes.

In a preferred embodiment, the desalination device comprises as at least one electrochemical cell the electrochemical cell just described. However, it is understood that the electrochemical cell can be equipped with other types of electrodes and supplied with other types of solutions to carry out other electrochemical reactions and is not, therefore. strictly related to the desalination described.

Plate electrochemical cells can be supplemented with additional plates creating stacks of cells that can be applied in desalination devices according to the invention, but also in other contexts that require different solutions and types of electrodes, while still working with the three-chamber principle of the smallest unit of the stack.

In a variant of the invention, a plurality of three-chamber electrochemical cells are grouped in a stack of cells according to:
variant (A) wherein the individual elements follow each other according to the following scheme:

[+AZC−][+AZC−]ₙ with n=1,2, . . . ;

OR according to:
the variant (B) in which the individual elements follow each other according to the following scheme:
+AZC−CZA+AZC−CZA+ . . . +AZC− with variable number of groups AZC and CZA wherein units with three adjacent chambers have the corresponding electrode in common,
wherein for both variants (A) and (B), A is a plate with anode chamber, Z is a plate with central chamber, C is a plate with cathode chamber, the sign “+” an anode and the sign “−” a cathode, between adjacent chambers A and Z an anion exchange membrane is placed and between adjacent chambers Z and C a cation exchange membrane; and
wherein for both variants (A) and (B) the chambers of the same kind are connected through the relative inlets and outlets of the chambers and corresponding holes in the plates.

The principle of plate electrochemical cells is illustrated later with reference to FIG. 2, wherein the configurations (number and arrangement) of the holes for connecting the inputs and outputs of the individual chambers may vary.

In an embodiment according to the invention for exploiting the technology on a large scale, the desalination device comprises not only at least one electrochemical cell but a plurality thereof, for example 50, in a multipolar configuration in a stack containing the alternating polarity cells. Advantageously, the active surface of the membranes and electrodes is approximately 1600 cm². The cell can be fed through a direct current generator at a voltage comprised between 0 and 9 Volts. In a preferred version of the invention, the cell is supplied with a constant voltage between 2.5 and 3.5 V and a current between 4.5 and 6.5 mA/cm² for each cell, for example through a photovoltaic system and a voltage stabiliser or through a direct current generator supplied by the mains voltage. Alternatively or in a supplementary form, it may be powered by the energy produced by the above-mentioned fuel cell. The amperage depends on the conductivity of the brine treated. For the same voltage, a brine less rich in salts produces a lower current and the above range can thus be extended to 0.5-6.5 mA/cm².

The flow of the saline solution to be treated is preferably kept stable within the central chamber of each cell, this in exemplary form through the use of peristaltic metering pumps that can be controlled using a Programmable Logic Controller (PLC) by monitoring the conductivity of the solution analysed at the point where it leaves the cell. Also inside the anode and cathode chamber, advantageously, a flow of anolyte/catholyte, such as a water flow, is kept stable, for example through the use of peristaltic metering pumps managed via PLC by monitoring the pH of the same solutions analysed at the point where they exit the cell.

In this regard, the desalination device according to the invention comprises adjustable speed pumping systems for feeding said chambers.

By controlling the pumping speed of the solution to be treated and the voltage applied to the cell, it is possible to carry out a continuous dynamic control of its desalination capacity, ensuring that a solution containing a level of chlorides consistent with the required values is available at the exit from the central chamber.

In an alternative embodiment of the invention, the desalination device further comprises a reverse osmosis system for dividing the solution exiting the central chamber into a fresh water fraction and a fraction of a concentrated saline solution which feeds in a circuit the central chamber of the electrochemical cell and wherein, preferably, the reverse osmosis plant is fed not just from the saline solution exiting the central chamber but also by brackish water. The brackish water has a salinity equal to or at least similar to that of the solution leaving the central chamber to withdraw an additional portion of potable water.

In the treatment of marine water, for example, this configuration makes possible the recovery of 100% of the water withdrawn as drinking water with zero discharge. This configuration is not the only one applicable. For example, in the case of industrial water treatment the electrochemical cells are used to lower the chloride levels below the one allowed for spillage into surface water.

A further aspect of the invention relates to a process for desalination comprising the following steps:
(a) providing a desalination device according to the invention;
(b1) feeding of the anode chamber with an anolyte, preferably water;
(b2) feeding the cathode chamber with a catholyte, preferably water or the base produced therein at reduced concentration;
(b3) feeding of the third chamber with a concentrated chloride salt solution;
(c1) oxidation of OH⁻ on the anode with the formation of oxygen O₂ and H⁺;
(c2) reduction of H⁺ on the cathode with formation of hydrogen H₂ and OH⁻ hydroxide ions;
(d1) in response to the increase in the concentration of H⁺ ions in the anode chamber, passage of salt anions, particularly chlorides, from the third chamber into the anode chamber;
(d2) in response to the increased concentration of OH⁻ ions in the cathode chamber, passage of salt cations, particularly Nat, from the third chamber into the cathode chamber.

The process uses an electrochemical cell or a stack of electrochemical cells according to the invention to lower the salt content of a concentrated saline solution and simultaneously to produce oxygen and hydrogen. As regards hydrogen, which cannot be contaminated by other gases, it can be used for energy production. Conversely, the oxygen in the anode chamber can be contaminated with chlorine by the anodic oxidation of Cl⁻. The base produced in the cathode chamber can be used to capture CO₂ from the atmosphere and produce carbonates and bicarbonates. The carbonation simultaneously transforms the concentrated base into a dilute base solution to be reintroduced into the cathode chamber, thus avoiding the need to introduce fresh catholyte.

In a preferred embodiment of the invention said at least one electrochemical cell is configured to work at a constant voltage comprised between 2.5 and 3.5 V and a current comprised between 4.5 and 6.5 mA/cm² (in the case of brines with a low concentration of salts a range between 0.5 and 6.5 mA/cm² is conceivable) for each cell causing the oxidation of the chloride inside the anode chamber forming gaseous chlorine which in turn spontaneously undergoes a dismutation reaction with consequent production of hydrochloric acid (HCl) and hypochlorous acid (HClO) in equal proportion. The following reactions are then added to the anode chamber:

2Cl⁻ [symbol] Cl₂(g)+2e⁻

Cl₂(g)+H₂O [symbol] HCl_{(aq)}+HClO_{(aq)}.

A supply voltage of at least 3 Volts makes it possible to obtain the oxidation reaction of the chloride inside the acid chamber with the consequent generation of gaseous chlorine. The gaseous chlorine diffused in aqueous solution spontaneously undergoes a dismutation or disproportionation reaction with consequent production of hydrochloric acid and hypochlorous acid in equal proportion. Control of the pumping rate of the feed water of the acid chamber enables control of the ratio between hydrochloric acid and hypochlorous acid at the exit of the chamber making it possible to obtain a solution containing active chlorine in the desired amount, for example to be used for the production of disinfectants. In order to ensure the further increase of concentrations of active chlorine obtainable, advantageously, it is possible to buffer the acid solution produced by the use of an appropriate base. This procedure makes it possible to increase further the residence time of the solution inside the acidification chamber.

In an embodiment of the process according to the invention,
(i) the anode chamber is fed at a controlled flow rate (with an acidic solution) and acidic solutions containing oxygen and preferably HCl and HClO are extracted from it;
(ii) the cathode chamber is fed at a controlled flow rate with a basic solution (NaOH) and concentrated basic solutions and hydrogen are extracted from it; and
(iii) the central chamber is fed at a controlled rate by concentrated saline solutions and diluted salt solutions are extracted. The control of speed makes it possible to monitor the concentrations of the components of the aqueous solutions contained in the relative chambers.

In an embodiment of the method according to the invention, the feeding of the cathode chamber and the extraction of its contents take place in a circuit from which the hydrogen is diverted, preferably by feeding a fuel cell, and comprising a carbonation reactor from which carbonates and/or bicarbonates are diverted with the effect of buffering the pH of the basic solution returning to the cathode chamber, preferably at values between 8.5 and 9.5. The energy produced in the fuel cell may be used to power the desalination device.

Further aspects of the invention relate to the use of the device and desalination process, in particular for reducing the concentration of chlorides in brackish water, industrial, mining or water treatment waste, in marine water according to the invention, and further for one or more purposes selected from the group consisting of:
production of carbonates and/or bicarbonates;
elimination of CO₂ from the atmosphere;
production of hydrogen to produce energy;
production of HCl and HClO for the manufacture of disinfectants.

The features and advantages disclosed for one aspect of the invention may be transferred mutatis mutandis to other aspects of the invention.

The industrial applicability is obvious from the moment when it becomes possible to reduce the concentration of chlorides from brackish water, marine water, industrial waste etc., even for chloride concentrations below 35,000 ppm in an economical way while being able at the same time to use the by-products such as hydrogen, HCl/HClO and NaOH to produce energy and carbonates/bicarbonates, and to reduce the carbon footprint in the environment.

Said purposes and advantages will be further highlighted during the description of preferred embodiment examples of the invention provided by way of non-limiting example only.

Variant and further features of the invention are the subject matter of the present application. The description of preferred embodiments of the device, process, electrochemical cell and uses relating to desalination and recovery and valorisation of chlorides contained in dilute solutions according to the invention is given by way of non-limiting example only with reference to the accompanying drawings. In particular, unless specified otherwise, the number, shape, dimensions and materials of the system and of the individual components may vary, and equivalent elements may be applied without deviating from the inventive concept.

### BRIEF DESCRIPTION OF THE DRAWINGS

FIG. 1 illustrates a schematic diagram of a desalination device according to the invention; and

FIG. 2 illustrates individual elements of an electrochemical cell usable in the device according to FIG. 1.

### DETAILED DESCRIPTION

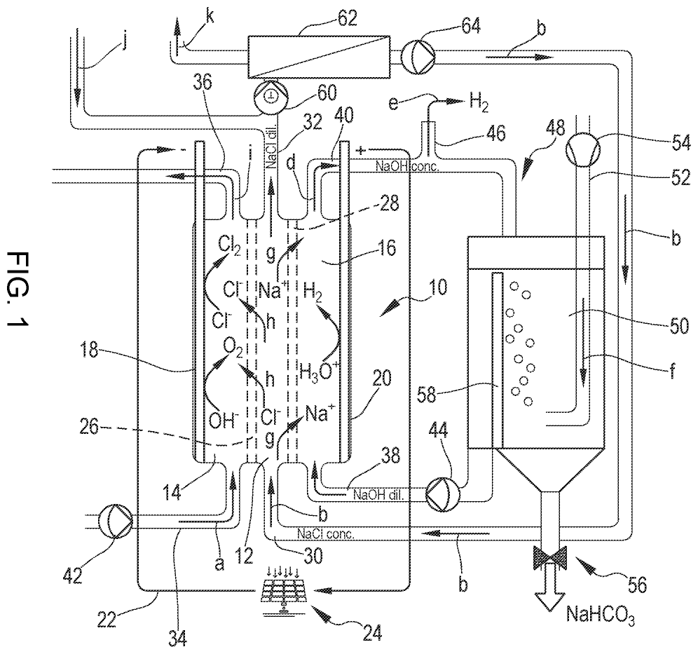

FIG. 1 illustrates a schematic diagram a desalination device according to the invention. The plant contains as a central element an electrochemical cell 10 comprising a central chamber 12, an anode chamber 14 and a cathode chamber 16. The anode chamber 14 contains an electrode, i.e. the anode 18. The corresponding electrode, the cathode 20, is located in the cathode chamber 16. The electrodes 18, 20 are connected by a circuit 22 powered by a photovoltaic cell 24. The electrons move from the negative electrode 18 to the positive electrode 20. The anode chamber 14 is separated by an anion exchange membrane 26 from the central chamber 12, while the cathode chamber 16 is separated from the central chamber 12 by a cation exchange membrane 28. Each of the three chambers 12, 14 and 16 is provided with an inlet and an outlet, the central chamber 12 of the inlet 30 and the outlet 32, the anode chamber 14 of the inlet 34 and the outlet 36 and the cathode chamber 16 of the inlet 38 and the outlet 40. Water (arrow a) is pumped by a pump 42 through the inlet 34 into the anode chamber 14. The central chamber 12 is fed through the inlet 30 with a concentrated NaCl solution (arrow b), for example 70 g NaCl/1. With a pump 44 a diluted basic aqueous solution, here NaOH with a concentration of 0.1 M, is pumped (arrow c) through the inlet 38 into the cathode chamber 16. At cathode 20, H₃O⁺ cations are reduced to form hydrogen H₂ according to reaction 2 H₃O⁺+4 e⁻→2 OH⁻+2 H₂ (g). The basicity of the solution in the cathode chamber 16 is then increased. The NaOH solution, which leaves (arrow d) the cathode chamber 16 via the outlet 40, is thus more concentrated (here 1M). At the same time, the hydrogen formed exits (arrow e) via the outlet 46 separating it from the aqueous NaOH flow which is managed in a circuit 48 connecting the inlet 38 and the outlet 40 of the cathode chamber 16. A carbonation reactor 50 is installed in circuit 48, the concentrated NaOH solution leaving the cathode chamber 16 enters the reactor 50 which is fed (arrow f) through a line 52 with the help of a pump 54 with a gas (i.e. air) containing carbon dioxide CO₂ that bubbles in the reactor 50. From the reaction between NaOH and CO₂ in water respectively, sodium carbonate and/or bicarbonate are formed and can be discharged via an outlet 56 from the reactor 50. The reactor 50 has a separator wall 58 for separating the formation of the solid carbonate/bicarbonate salts from the circuit 48.

In the anode chamber 14 OH⁻ ions are oxidised to form oxygen O₂ according to reaction 4 OH⁻ [symbol] 4e⁻2 H₂O+O₂ (g). The aqueous solution results in a lower pH as the H₃O⁺ ion concentration increases.

The concentrated NaCl solution introduced into the central chamber 12 is diluted as reactions occur at the electrodes 18, 20 because the Na cations cross (arrows g) the cation exchange membrane 28 reacting to the increase in the concentration of OH⁻, while Cl⁻ anions cross (arrows h) the anion exchange membrane 26 reacting to the increase in the concentration of H₃O⁺. At the outlet 32 of the central chamber 12, a dilute NaCl solution of about 35 g/l exits. The Cl⁻ ions entering the anode chamber 14 are oxidised at anode 18 forming Cl₂ chlorine. Chlorine reacts with water to form HCl and HClO, here about 1 molar, and exits (arrow i) from outlet 36.

The diluted saline solution exiting the central chamber 12 is admixed with brine of similar concentration (arrow j) and pumped with a pump 60 into a reverse osmosis plant 62 from which a fresh water fraction (arrow k) and a concentrated NaCl solution fraction (70 g/L) are obtained and pumped with a pump 64 into the central chamber 12 forming the NaCl flow (arrow b).

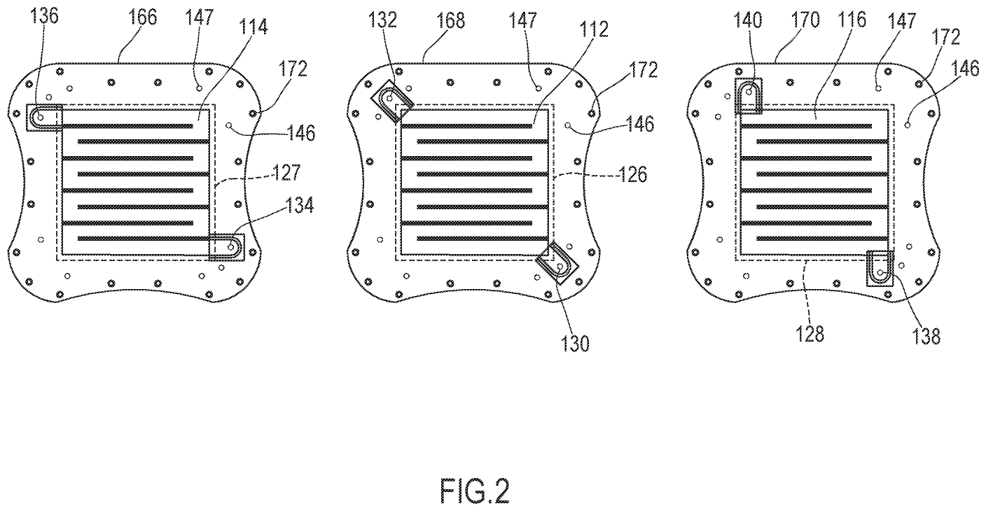

FIG. 2 illustrates individual elements of an electrochemical cell usable in the plant according to FIG. 1. From left to right can be observed a first plate 166 with an anode chamber 114, a second plate 168 with a central chamber 112, and a third plate 170 with a cathode chamber 116. Each chamber follows a meandering or serpentine path.

In a three-chamber base cell which stands alone or in an isolated form according to the above variants (A) or (B) in a succession of a plurality of three-chamber units, an anion exchange membrane 127 is at all times interposed between the anode chamber 114 and central chamber 112 and between the central chamber 112 and cathode chamber 116 a cation exchange membrane 128. In the left-hand plate 166 the reference number 127 indicates the anion exchange membrane placed above the anode chamber 114; in the plate 170 on the right the reference number 128 indicates the cation exchange membrane placed above the cathode chamber 116, while in the plate 168 in the centre the reference number 126 indicates the set of the anion and cation exchange membranes (also represented individually in the drawings on the side) that include the central chamber 112 as in a sandwich.

By placing the second plate 168 above the first plate 166 and the third plate 170 above the second plate 168 with the anion exchange membrane 127 between the first 166 and second 168 plate, and the cation exchange membrane 128 between the second 168 and third 170 plate, a base electrochemical cell is obtained. To connect one plate to the other, a plurality of holes 172 is provided along the edge of each plate that serve to pass relative fixing means. By repeating the construction of electrochemical cells several times and placing one cell on top of the other, according to the sequences illustrated above, a stack of electrochemical cells is obtained that can be connected to work together. In this regard, each plate is provided with two three-hole assemblies, one for the outlets of the relative chambers 114, 112 and 116, and one for the inlets of the relative chambers. The anode chamber 114 of the first plate 166 connects at its ends to the outlet hole 136 and to the inlet hole 134; the central chamber 112 connects at its ends to the outlet hole 132 and to the inlet hole 130; and the cathode chamber 116 connects at its ends to the outlet hole 140 and to the inlet hole 138. Thus, in a stack of electrochemical cells, the outlets and inlets of the individual chambers are connected together, creating a unique flow of anodic solution, saline solution and cathodic solution between the chambers of the same category (anodic, central or cathodic).

Furthermore, there are holes 146, 147 on each plate that can be aligned in the stack that serve for the degassing of the anode and cathode chambers where gases are produced, in particular in the case of the connected cathode chambers 116, the relative holes 146 serve to create channels to convey the hydrogen formed.

The plates are made in the form of chips and have, by way of example, a thickness of approximately 6 mm.

1. Desalination A desalination device comprising at least one electrochemical cell comprising:
(a) an anode suitable for allowing the electrochemical reaction of oxidation of the OH⁻ ion and consequent production of oxygen gas and release in solution of protons H⁺ wherein said anode is contained in an anode chamber suitable for containing or containing as an anolyte an acidic solution;
(b) a cathode connected through an electrical connection to said anode and suitable to allow the electrochemical reaction of reduction of proton H⁺ and consequent production of hydrogen gas and release in solution of OH⁻ ions wherein said cathode is contained in a cathode chamber suitable to contain or containing as a catholyte a basic solution, in particular an aqueous solution of NaOH;
(c) a system for feeding said anode chamber with said acidic solution;
(d) a system for feeding said cathode chamber with said basic solution;
(e) a cation exchange membrane impermeable for OH⁻ ions and permeable for cations, in particular Na⁺;
(f) an anion exchange membrane impermeable for H⁺ ions and permeable for anions, particularly Cl⁻;
wherein said anodic chamber and said cathodic chamber are separated by said cation exchange membrane and said anion exchange membrane which in turn are separated by a third chamber suitable for containing or containing an aqueous solution of chloride salt, in particular NaCl,
where
(α) said cation exchange membrane is simultaneously a wall or a portion thereof of said cathode chamber and of said third chamber such that from the third chamber to the cathode chamber a passage of salt cations, in particular Na+, is possible;
(β) said anion exchange membrane is simultaneously a wall or a portion thereof of said anode chamber and of said third chamber such that from the third chamber to the anode chamber a passage of salt anions, in particular Cl⁻, is possible.

2. The desalination device according to claim 1, wherein said electrodes are made of stainless steel or graphite.

3. The desalination device according to claim 1, wherein said desalination device is configured to perform the following steps:
(i) feeding the anode chamber with an anolyte, preferably water;
(ii) feeding the cathode chamber with a catholyte, preferably water or the base produced therein at reduced concentration;
(iii) feeding the third chamber with a concentrated chloride salt solution;
(iv) oxidation of OH⁻ on the anode with the formation of oxygen O₂ and H⁺ protons;
(v) reduction of H⁺ on the cathode with the formation of H₂ hydrogen and OH⁻ hydroxide ions.

4. The desalination device according to claim 1, wherein each of said chambers is provided with an inlet and an outlet, namely:
(a) that the anode chamber is provided with an inlet for fresh anolyte and an outlet for anolyte enriched with salt anions, particularly Cl⁻, or their derivatives, and oxygen;
(b) that the cathode chamber is provided with an inlet for the fresh catholyte and an outlet for the catholyte enriched in salt cations, particularly Na⁺, and hydrogen; and
(c) that the third chamber has an inlet for the aqueous starting salt solution and an outlet for the reduced concentration salt solution.

5. The desalination device according to claim 1, further comprising
(g) a gas-liquid separation device, in particular a gas-liquid scrubber, for recovering the hydrogen produced which is connected to the outlet of the cathode chamber and which is connected to a fuel cell.

6. The desalination device according to claim 1, further comprising:
(h) a carbonation reactor wherein the cathode chamber comprises an inlet and an outlet which are connected in a circuit in which said carbonation reactor is inserted.

7. The desalination device according to claim 1, wherein said at least one electrochemical cell comprises:
(i) a first plate supporting in a first window applied in said first plate said anode chamber of meandering path having a thickness with respect to the plane of the meandering path extension preferably not exceeding 6 mm and having an inlet and an outlet for the anolyte at its ends;
(ii) a second plate supporting in a second window applied to said second plate said central chamber of meandering path having a thickness relative to the plane of the meandering path extension that preferably does not exceed 6 mm and having an inlet and outlet for saline solution at its ends; and
(iii) a third plate supporting in a third window applied in said third plate said cathode chamber of meandering path having a thickness with respect to the plane of the meandering path extension that preferably does not exceed 6 mm and having an inlet and outlet for the catholyte at its ends,
(iv) said anion exchange membrane interposed between said first and said second plate;
(v) said cation exchange membrane interposed between said second and said third plate;
(vi) a plate anode disposed alongside said first plate on the opposite side from the position of said anion exchange membrane; and
(vii) a plate cathode disposed alongside said third plate on the opposite side with respect to the position of the cation exchange membrane;
wherein plates, membranes and electrodes are superimposed in the following order: anode, anode chamber, anion exchange membrane, central chamber, cation exchange membrane, cathode,
wherein each plate is optionally provided with a plurality of first holes arranged so that as the plates are overlapped, they are aligned so that they can be connected with relative fastening means;
wherein each plate is provided with a plurality of second holes divided into three pairs of holes for conveying in separate channels the flows of anolyte, catholyte and saline solution, one hole of each pair provided for inlet of the respective flow into the system and the other hole for exit from the system wherein the corresponding holes are arranged so that with the overlapping of the plates they result aligned to be able to connect them to form separate channels for the respective flows,
wherein each plate is preferably provided with a plurality of third holes for collecting gases formed in the anode and cathode chambers respectively and arranged in such a way that with the overlapping of the plates they result aligned to be able to connect them to form separate channels for the relative gas flows of the respective chambers,
in which each flow traverses along the channel formed by the relative overlapping holes the whole system, but only in the plate carrying the chamber to which the relative channel flow is dedicated a communication with the chamber inlet is realized in such a way as to allow the flow to pass through the chamber and enter through the chamber outlet into the corresponding outlet channel formed by the respective set of holes.

8. The desalination device according to claim 7, further comprising a plurality of three-chamber electrochemical cells which is grouped into a cell stack according to variant (A) wherein the individual elements follow each other according to the following scheme: [+AZC−][+AZC−]ₙ with n=1, 2, . . . ;
OR according to
variant (B) in which the individual elements follow each other according to the following scheme: +AZC−CZA+AZC−CZA+ . . . +AZC− with varying number of AZC− and CZA− groups in which units with three adjacent chambers have the corresponding electrode in common,
wherein for both variants (A) and (B) A is a plate with an anode chamber, Z is a plate with a central chamber, C is a plate with a cathode chamber, the “+” sign an anode and the “−” sign a cathode, an anion exchange membrane is placed between adjacent chambers A and Z, and a cation exchange membrane is placed between adjacent chambers Z and C; and
wherein for both variants (A) and (B) the chambers of the same type are connected through the relative inlets and outlets of the chambers and corresponding holes in the plates.

9. The desalination device according to claim 1, further comprising a plurality of electrochemical cells in a multipolar configuration in a stack containing the cells with alternating polarity.

10. The desalination device according to claim 1, further comprising pumping systems with adjustable speed for feeding said chambers.

11. The desalination device according to claim 1, wherein said electrochemical cell is configured to operate at a voltage between 2.5 and 3.5 V and a current between 0.5 and 6.5 mA/cm².

12. A desalination process comprising the following steps:
(a) providing a desalination device according to claim 1;
(b1) feeding the anode chamber with an anolyte, preferably water;
(b2) feeding the cathode chamber with a catholyte, preferably water or the base produced therein at reduced concentration;
(b3) feeding of the third chamber with a concentrated chloride salt solution;
(c1) oxidation of OH⁻ on the anode with the formation of oxygen O₂ and protons H⁺;
(c2) reduction of H⁺ on the cathode with the formation of hydrogen H₂ and hydroxide ions OH⁻;
(d1) in reaction to increased concentration of H⁺ ions in the anode chamber passage of salt anions, particularly chlorides, from the third chamber into the anode chamber;
(d2) in reaction to the increased concentration of OH⁻ ions in the cathode chamber passage of salt cations, particularly Na⁺, from the third chamber into the cathode chamber.

13. The process according to claim 12, wherein said at least one electrochemical cell is supplied with a voltage between 2.5 and 3.5 V and a current between 0.5 and 6.5 mA/cm², preferably between 4.5 and 6.5 mA/cm² causing the oxidation of chloride within the anode chamber (14; 114) forming chlorine gas which in turn spontaneously undergoes a dismutation reaction resulting in the production of hydrochloric acid (HCl) and hypochlorous acid (HClO) in equal proportions.

14. The process according to claim 12, wherein
(i) the anode chamber is fed with controlled flow, in particular with an acid solution or water, and that acid solutions containing oxygen and preferably HCl and HClO are extracted therefrom;
(ii) the cathode chamber is fed with controlled flow with a basic solution, particularly NaOH, or with water and that concentrated basic solutions and hydrogen are extracted therefrom;
(iii) the central chamber is fed at a controlled rate by concentrated salt solutions and that dilute salt solutions are extracted therefrom allowing control of the concentrations of the components of the aqueous solutions contained in the relevant chambers.

15. The process according to claim 12, wherein the feeding of the cathode chamber and the extraction of its contents take place in a circuit from which hydrogen is diverted, preferably feeding a fuel cell, and comprising a carbonation reactor from which carbonates and bicarbonates are diverted with the effect of buffering the pH of the basic solution which returns to the cathode chamber, preferably at values between 8.5 and 9.5, in which the energy produced in the fuel cell can be used to power the desalination device.

16. A method of using the desalination device according to claim 1 for reducing the concentration of chlorides in brackish water, industrial waste, mining, water treatment, or marine waters for one or more purposes selected from the group consisting of:
production of carbonates and/or bicarbonates;
removal of CO₂ from the atmosphere;
production of hydrogen for the purpose of producing energy;
production of HCl and HClO for the production of disinfectants.
